(19) United States
(12) Patent Application Publication
(10) Pub. No.: US 2018/0137841 A1
(43) Pub. Date: May 17, 2018

(54) STAND FOR A STRINGED INSTRUMENT

(71) Applicant: STANDLEY IVS, København N (DK)

(72) Inventors: Murad MAHMOUD, Ølstykke (DK); Juan ALMAJID, Valby (DK); Gennadios SKALENKO, Søborg (DK)

(21) Appl. No.: 15/572,677

(22) PCT Filed: May 4, 2016
(86) PCT No.: PCT/DK2016/050116

§ 371 Date: Nov. 8, 2017

(30) Foreign Application Priority Data
May 13, 2015 (DK) PA 2015 70283

(51) Int. Cl. G10D 1/08; G10G 5/00

(52) U.S. Cl. CPC G10D 1/08; G10G 5/00

(57) ABSTRACT

A stand (2; 18; 31) for a stringed instrument (1) is adapted to be placed in either a playing position for playing music or a parking position in which the instrument (1) is placed on the ground with the head (3) uppermost and the body (5) lowermost. The stand (2; 18; 31) has a foot member (6; 6′; 32) for supporting the instrument (1) in the parking position, an upper connector (7; 7″) placed on the lower end face (8) of the instrument body (5), and a lower connector (9; 19, 20; 36) arranged on the foot member (6; 6′; 32) whereby the connectors are arranged for permanent or temporary interconnection. The stand is placed beneath the lower end face (8) of the body (5) of the stringed instrument (1) and within the borders of the end face (8) for providing a nice appearance of the parked stringed instrument (1).

### A STAND FOR A STRINGED INSTRUMENT

The invention relates to a stand configured to arrange a stringed instrument in an erected parking position.

The invention relates in particular to a stand for a guitar, preferably a stand that can be detachably connected to the stringed instrument, such as a guitar.

Japanese patent application no. 2005-189718 discloses a small stand for erecting a guitar in a parking position. This known stand has a foot member beneath the guitar body and a small backrest in extension of the foot member. The foot member has a ratchet groove for receiving a tap on the guitar body. The tap is forced along the ratchet along the depth of the guitar body until the backrest of the stand is in contact with the back, that is the non-stringed side, of the erected guitar, thus the parked guitar. This known stand needs to fit well together with the specific stringed instrument to avoid undesired mechanical contact, and thus avoiding scratching the guitar body during mounting and demounting the stand when operating the ratchet coupling. Moreover, if the stand is not mounted correctly the centre of gravity will not be positioned to keep the stringed instrument parked. This is however not critical either, due to the provision of the back stand. Yet a disadvantage is that the stand is disfiguring because it is highly visible beyond the borders of the guitar body. Yet a disadvantage is that this known stand takes up space behind the guitar.

Stands with backrests are specifically disclaimed and not part of the present invention.

Furthermore, ratchet couplings are not suited for the stand of the present invention on the one hand because it is impossible to move an upper connector on the stringed instrument inside the ratchet coupling of the stand to the exact same position each time in the absence of a backrest. Thus without the backrest a stand with a ratchet coupling cannot be repeatingly perfectly hidden below the lower end face of the instrument body when the stringed instrument is in it's parking position.

On the other hand because an upper connector, e.g. a tap, is susceptible to unintentionally slide in the ratchet coupling when the stringed instrument is parked. So if the lower coupling is a ratchet the stringed instrument is at risk of tilting if the backrest is not present. Moreover interconnection by means of ratchets does not lock sufficiently reliable. Moreover sliding a tap in a ratchet quickly wears down the ratchet and leaves disfiguring marks on the tap. The faster the wear of a ratchet the more unreliable would interconnection be.

Other stands for stringed instrument are well known within the art. Such stands serve to support the stringed instrument when this stringed instrument is not used. Such stands are often voluminous, heavy, expensive, and do not look good. So these prior art stands all suffer various disadvantages, which according to the invention are remedied by,

in a first aspect of the invention providing a stand of the kind mentioned in the opening paragraph, which is easy and handy to operate when connecting the stand to the musical instrument and disconnecting the stand from the musical instrument,

in a second aspect of the invention providing a stand of the kind mentioned in the opening paragraph, which is formed with small geometrical extent in relation to the lower end face of the musical instrument,

in a third aspect of the invention providing a stand of the kind mentioned in the opening paragraph, which when the instrument is connected to the stand, gives the nice appearance that the musical instrument hangs substantially baseless in mid-air,

in a fourth aspect of the invention providing a stand of the kind mentioned in the opening paragraph which can remain attached to the musical instrument when the musical instrument is played without reducing the quality of the sound of the music played and without causing inconvenience to the musician playing the musical instrument,

in a fifth aspect of the invention providing a detachable stand of the kind mentioned in the opening paragraph, which can be attached and detached without tools and does not take up substantial space beyond the limits and borders of the musical instrument when said instrument is parked using the stand.

The novel and unique features according to the invention whereby these and other aspects are achieved consist in the fact that

the stand comprises a foot member with a lower connector configured to interconnect with an upper connector located at the lower end face of the instrument body in the erected parking position, and

the stand has no backrest for the stringed instrument when said stringed instrument is in the parking position.

For the present invention the stand has no backrest. Even though the stringed instrument becomes self-standing due to the upper connector and the lower connector interconnect, engage and/or interlock the stand to the stringed instrument. The stringed instruments can be parked easily and fast, without the need to unfold or assemble a complex, disfiguring frame or backrest. Moreover, without the backrest the stand does not take up valuable space during storage and transport.

It is important that a valuable stringed instrument doesn't overturn when parked. Often there is limited available space to place the instrument on, and a backrest takes up space. The unexpected presence of a backrest or other protruding part of the stand constitute a risk that people stumble over or hits the stand when passing by the stringed instrument. The unfortunate event of overturn of a parked stringed instrument could disturb e.g. a concert, and even more important, it could damage the valuable stringed instrument.

The easy parking by means of the stand without backrest according to the present invention in e.g. a concert hall during a concert does not disfigure the overall impression of the orchestra since the stands and any feet can hardly or not at all be seen from the seats of the audience, just the stringed instrument. Moreover, the stringed instrument can be grasped easily without a disturbing noise from the decoupling action from a ratchet coupling. The stringed instrument can be played with or without the foot member being secured to the lower end face of the instrument body of the stringed instrument.

The stand is adapted for being placed underneath a lower end face of the instrument body of a stringed instrument and within the geometrical borders of said lower end face, so the foot member can advantageously be sized and dimensioned so that the foot member has a size and shape that does not extend a geometrical border of the area at the mounting location at the lower end face of the instrument body when the stringed instrument is in it's parking position.

A stringed instrument needs to be securely kept in balance when being placed in parking position. To that aspect conventional frames or stands use the wide legs or backrest to support stringed instruments in the parking position, which makes the stringed instrument to stay erected in a tilted orientation, of e.g. 20°.

For the stand according to the present invention no backrest is present. The stand arranges the stringed instrument in a substantially vertical position. In case a small tilting of e.g. 5° is preferred the centre of gravity of the stringed instrument is to be taken into account when dimensioning and configuring the stand.

Prevention of overturning and obtaining the required balance can thus e.g. be achieved by placing the first axis of the upper connector coincident with the second axis of the instrument body.

Yet an option that improves the balance of the stringed instrument in the parking position using the stand of the present invention is to have the third axis of the lower connector to be coincident with the fourth axis of the foot member.

In one embodiment all said axes are coincident.

Preferably the fourth axis can pass through the centre of gravity of the stringed instrument to obtain a very stable parking position and parking situation for the stringed instrument.

The stand of the present invention confers an expedient easy operatable, “self-standing”, property to the stringed instrument.

Thus the relations between the axes as stated above may arrange the stringed instrument in a substantially vertically erected parking position in relation to the surface on which the stand is placed. Exact vertical is, as mentioned above, not mandatory for all embodiments of the present invention. As mentioned above deviations from vertical of e.g. about 2°-5° may be acceptable provided the centre of gravity is not too high or noticeable displaced in relation to the first and second axes.

According to the invention a particular stable and reliable interconnection between the stand and the stringed instrument can be obtained by forming the top side of the foot member with a concave curvature, so that a first radius of said curvature can correspond to or be shorter than a second radius of a curved lower end face of the instrument body, and so that a centre of the curvature can be situated on the second axis of the instrument body in the interconnected state of the lower connector and the upper connector. Thus by making the upper face of the foot member more or less concave the face of the topside of the stand, thus the face facing the stringed instrument, have been given a shape and curvature that is substantially complementary to the shape and curvature of the lower curved end face of the instrument body.

A simple, inexpensive and easy operable configuration of the upper and lower connectors can, according to the invention, be obtained if the upper connector is a female connector and the lower connector is a male connector, or vice versa. Expediently the female connector and the male connector can have mating parts of complementary shape.

The upper connector may have both male and female properties so that the stringed instrument can couple together with both female and male lower connectors.

An exemplary upper connector is a female connector, e.g. a bush with a hole for engaging a lower connector in form of a male connector, e.g. a tap fitting into said hole. The tap may thus fit engagingly inside the hole of the bush to interconnect the stringed instrument and the foot member to obtain a standing not-wobbling or insecure configuration of the combined stand and stringed instrument in the interconnected condition. In the alternative a bush could constitute the upper male connector being surrounded externally by a lower female connector.

In one embodiment a jack plug or strap button of the stringed instrument is simply utilised as the upper male connector, the tap. Jack plugs and strap buttons comes in various sizes and the lower connector may conveniently be adapted to engage such various sizes firmly. By using the jack plug or the strap button as one of the connectors no extra components need to be fitted to the stringed instrument, simply a component already present on the stringed instrument is utilized.

A particular safe interconnection and engagement between the upper connector and the lower connector, and thereby between the stringed instrument and the stand, can be achieved if at least one of the upper connector or the lower connector has means for providing friction against the respective other of said connectors when interconnecting.

The means for providing friction can e.g. be an elastic lining, such as at least one elastomeric ring. Such an elastomeric ring can simply be provided around a male connector or be included in the lining of a female connector, or both.

For example at least a free end of a male connector in form of a tap can have an elastic lining thereby providing said free end with an outer diameter larger than the inner diameter of female connector, e.g. a bush featuring a hole for receiving the tap. The elastic lining or other similar means for creating a level of friction that improves engagement and increases connecting force between the upper connector and the lower connector serves to maintain the stringed instrument firmly in the parking position by means of the connected stand.

Elastic lining(s) in form of at least one elastomeric ring can e.g. be rubber ring(s), which has/have an outer diameter somewhat larger than the inner diameter of the hole in the bush or other kind of upper connector.

In yet an embodiment, with or without friction means, the lower connector can be a clamping means for clamping around a male upper connector that protrudes from the instrument body.

A suitable clamping means may comprise a stationary jaw and a movable jaw, which movable jaw e.g. can be forcible against the stationary jaw by means of a first spring mechanism to open and close an opening to grasp around the upper connector, e.g. a protruding tap on the stringed instrument. Such clamping means can conveniently be spring-biased, so that when the male connector is inserted between said jaws the first spring mechanism forces the jaws towards each other because the first spring mechanism urges towards its less compressed condition, thus the first spring mechanism attempt to return to its most relaxed condition. In such an embodiment the spring force applied to the moveable jaw may conveniently act along the depth of the instrument body of the stringed instrument, in other words cross-wise the width of the instrument body of the stringed instrument.

In this alternative embodiment the exterior face of the upper connector is utilized instead of it's bore as for some of the above-mentioned embodiments. The upper connector, which can be a jack plug or a stap buttom, then constitutes the male upper connector, whereas the female connector for receiving and engaging the upper connector is provided by the stand.

This kind of connection wherein the upper connector is a tap or other kind of connector-object protruding from the stringed instrument, and the lower connector comprises a bush or a clamping means, which fits to clamp around the tap or similar functional protruding object, and consists of a stationary jaw and a movable jaw, is strong and durable, and can still be operated by just one hand for connecting the upper connector and the lower connector.

The upper connector may be formed with a groove and the clamping means be formed with a rib fitting into said groove so that the clamping means, and thereby the foot member, only intentionally can be pulled from the upper connector, and thereby from the stringed instrument.

If the stationary jaw is part of an adaptor to be introduced in the foot member, the stand is particular easy to mount to the stringed instrument.

Alternatively, the lower connector may have clamping means that advantageously may comprise a second spring mechanism accommodated in a spring compartment in the foot member, via which spring compartment the second spring mechanism is accessible to interconnect with the upper connector. The upper connector can then simply be inserted in the spring compartment by first moving the upper connector and the lower connector towards each other in a direction substantially perpendicularly to the foot member, and then moving the stand parallel to the end face of the stringed instrument so that the second spring mechanism snaps onto the upper connector in the correct position for the stringed instrument to stand firmly parked.

The second spring mechanism of the lower connector may comprise a first spring leg opposite and spaced apart from a second spring leg, which opposite spring legs are arranged substantially parallel to a main plane of the foot member for interconnection of the upper connector by sideways displacement of said upper connector between said spring legs.

In this alternative embodiment the spring force applied to the opposite spring legs may conveniently acts along the length of the instrument body of the stringed instrument.

The clamping means with the spring mechanism may be included in an adapter.

The adaptors, clamping means and spring mechanisms implemented in the stands of the present invention constitute expedient interconnection means for mounting the stand on the stringed instrument without tools. The stand is mounted by a simple series of movements and displacements of the upper connector and the lower connector in relation to each other so that only by reversing the series of steps disconnection can take place.

So in any of the embodiments of a stand according to the present invention accidental disconnections between upper connector and lower connector are advantageously avoided. This advantage is particular noticeable and prominent for the embodiments implementing clamping means in forms of opposite acting clamping jaws or having a second spring mechanism including oppositely acting spring legs.

The foot member may have an adjusting screw to adjust the distance between the lower end face of the instrument body of the stringed instrument and the foot member. Optionally the adjusting screw may provide the further functionality of being capable of being screwed until an end of the adjusting screw abuts against the lower end face of the instrument body of the stringed instrument, so that the adjusting screw serves as a retainer for preventing dislocation of the position of the stand on the stringed instrument and prevent the stand from rotating about any of the first axis, the second axis, the third axis and/or the fourth axis.

The foot member may be configured as a centre body comprising more or less of the adapter, e.g. the clamping means, and having at least two support legs radiating from the centre body. This design is very easy to grasp and manipulate for interconnection of the upper and lower connector, and the person doing the interconnection is inherently guided by the structural design to move the clamping means, e.g. the spring compartment, towards the upper connector.

At least one or more of the support legs of the foot member may have at least one adjusting screw to ensure the proper locating, mounting and levelling of the stand on the stringed instrument. Thus the adjusting screws serve the further function of levelling screws, that, if preferred, provide some freedom to arrange the stringed instrument in a slightly inclined posture in the parking position, and as clamping screws to make sure that the optimum position and securing of the stand on the stringed instrument is observed and engaged.

For many embodiments of the present invention the erected parking position is substantially vertical.

In order not to scratch or otherwise damages the end face of the instrument body an end of an adjusting screw that faces towards the instrument may have a protective termination.

The foot member may conveniently be formed as a cross body where the lower connector is situated at a centre part or at an intersecting part of the legs of the cross body, and the legs of the cross body radiate, preferably in the plane of the foot member, from the centre part or the intersection part.

The centre part or the intersecting part of the cross body may include the spring compartment and/or the adapter, and the support legs may radiate from said respective spring compartment and/or adapter.

The legs of the cross body may act as the support legs.

The invention will be explained in greater details below by disclosing further advantageous and technical effects and describing exemplary embodiments with reference to the drawing, in which

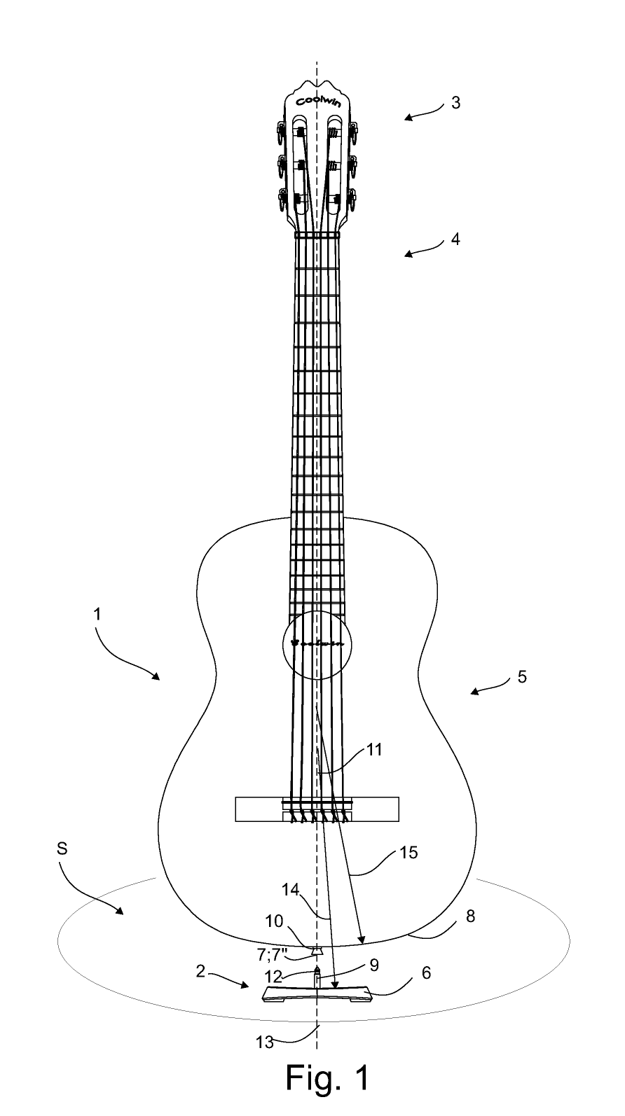

FIG. 1 is an exploded view of an exemplary stringed instrument, a guitar, and of a first embodiment of the stand according to the invention, seen in upright position,

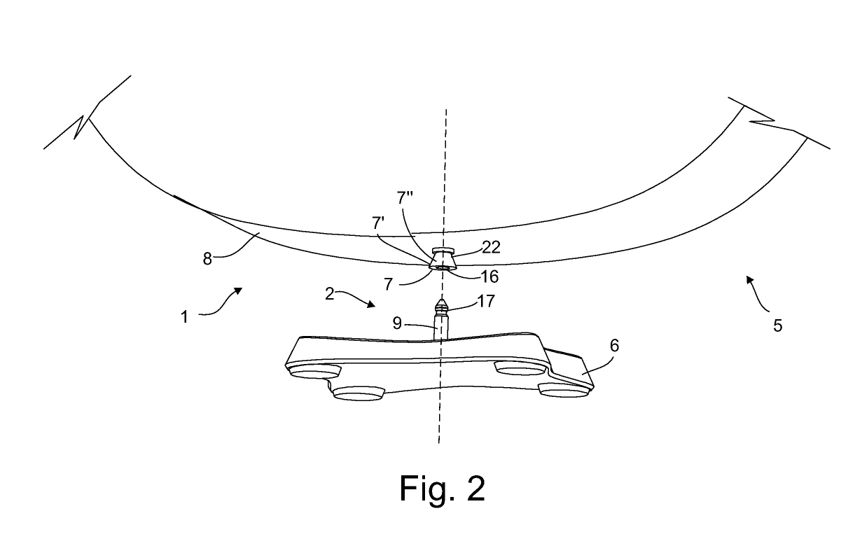

FIG. 2 shows in an enlarged scale, in perspective, a fragment of the exploded view, seen in FIG. 1,

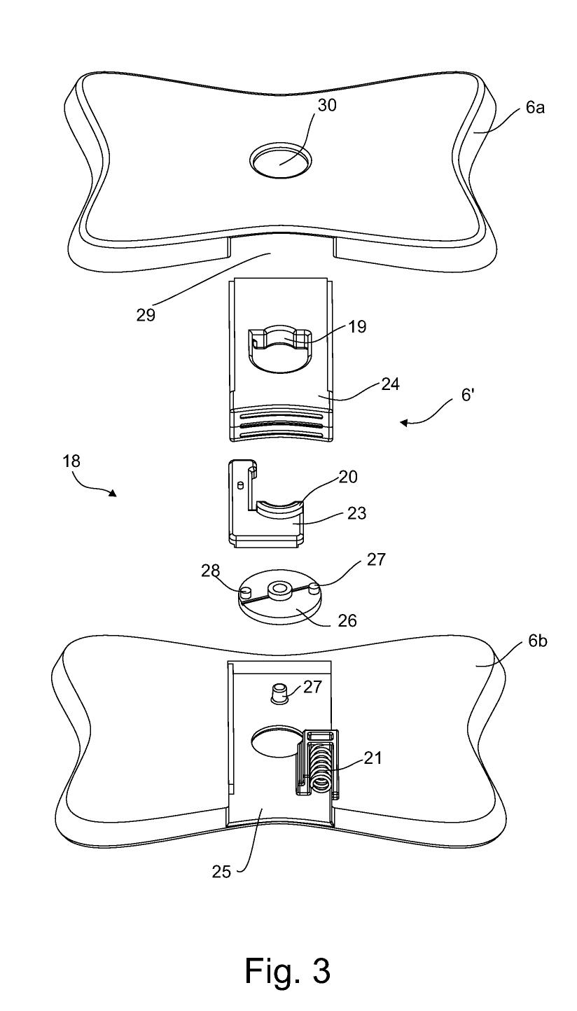

FIG. 3 shows, seen in a starting position, in perspective from above, an exploded view of a second embodiment of the stand according to the invention,

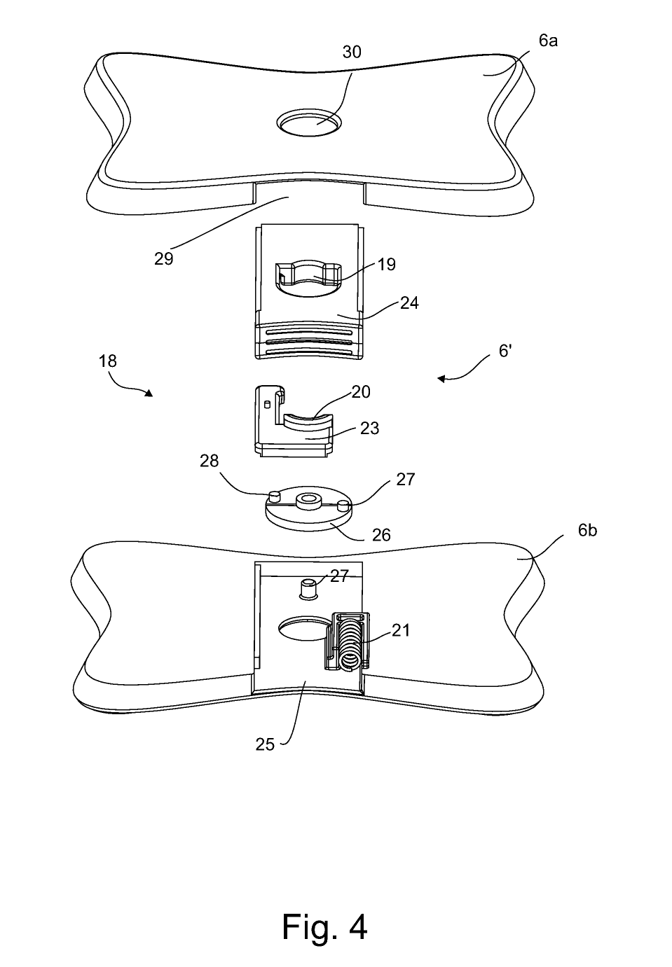

FIG. 4 shows the same in a closed position,

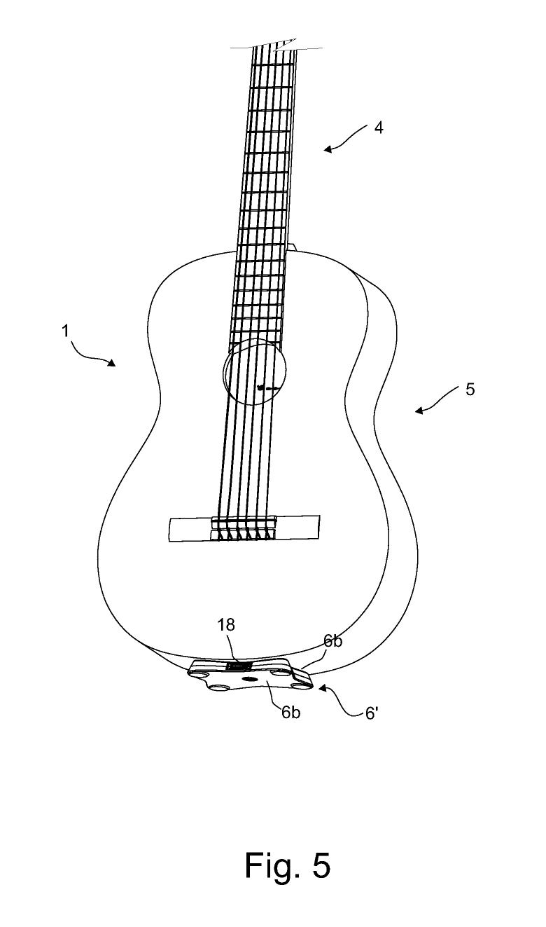

FIG. 5 shows, seen in perspective from the outside, a stand mounted on a stringed instrument,

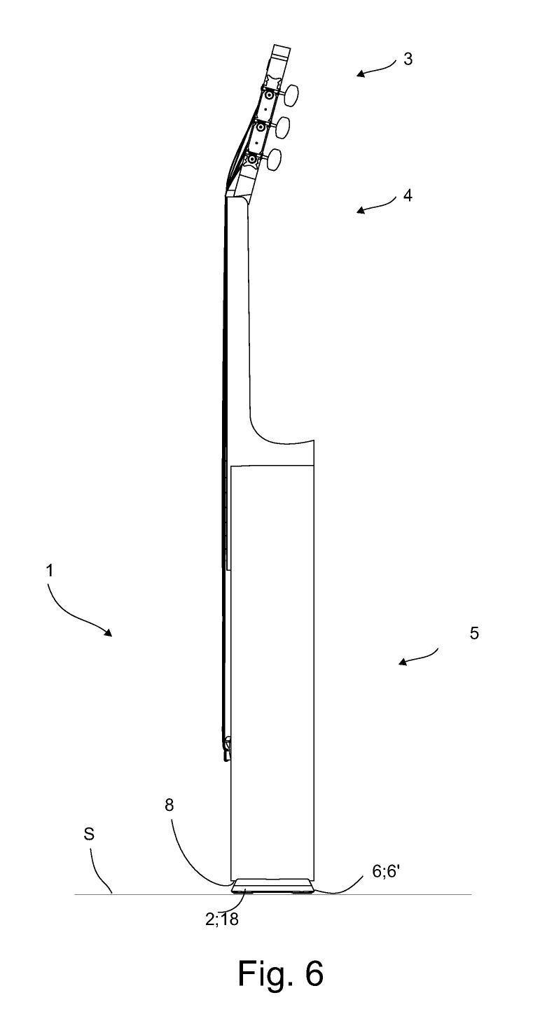

FIG. 6 shows the guitar seen in FIG. 5 but from the side with the stand in assembled state,

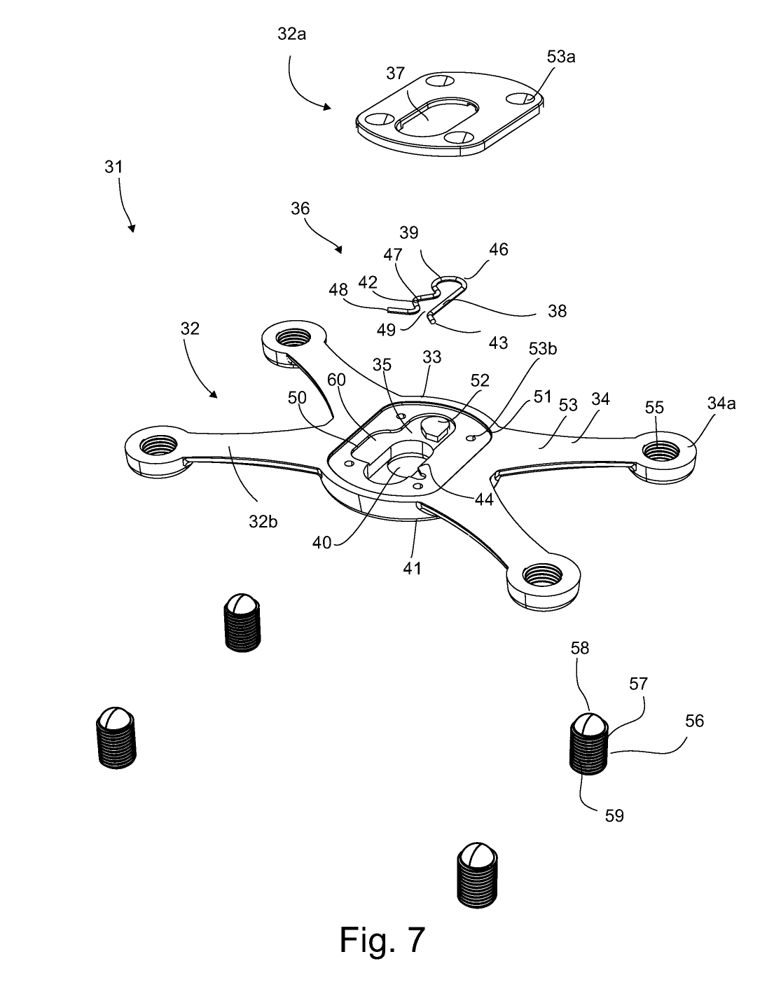

FIG. 7 is an exploded perspective view of the components of a third embodiment of a stand seen from above,

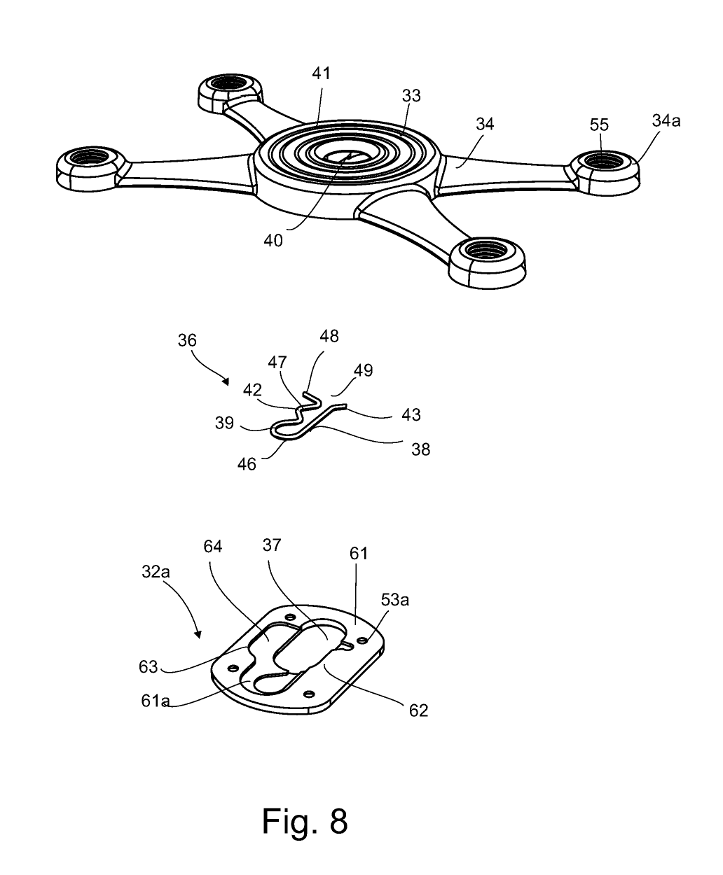

FIG. 8 shows the same seen from below without adjusting screws, and

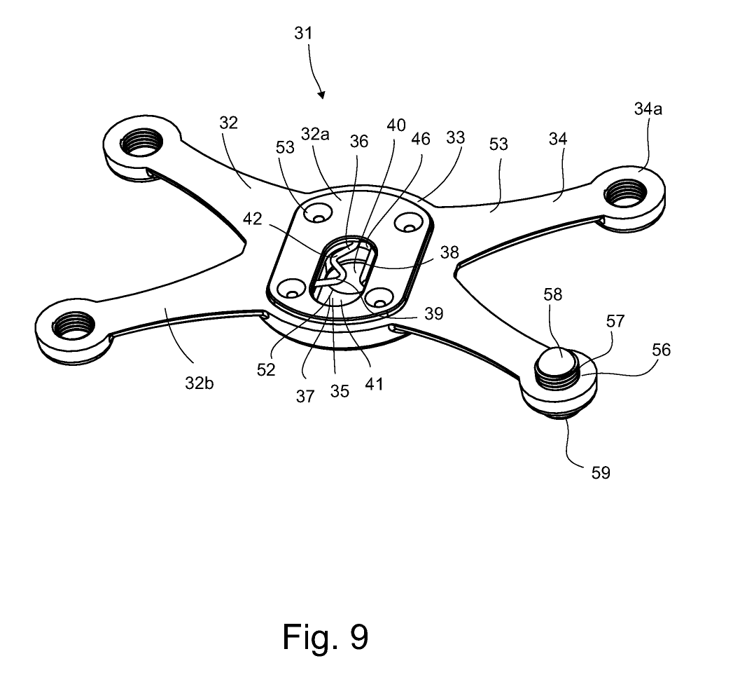

FIG. 9 shows the same in assembled state with just one adjusting screw.

In the following description of the invention it is supposed that the musical instrument is a stringed instrument in form of a guitar. It can however be any kind of stringed instrument, such a banjo, violin, string bass, viola, etc. Any other instruments, that by itself has no inherent self-standing properties, and whereto an upper connector can be secured, including by adhesives or magnetism, are contemplated within the scope of the present invention.

FIGS. 1 and 2 show a guitar 1 and a first embodiment of a stand 2. The guitar 1 is a conventional acoustic guitar 1 wherein the main structural components are a head 3, a fingerboard 4 and an instrument body 5, while the stand 2 mainly consists of a foot member 6 and a lower connector 9 placed on the foot member 6 of the stand 2. An upper connector 7 is placed on the instrument body 5 of the guitar 1. In the present first embodiment the upper connector 7 is a separate component attached to the instrument body 5, but in case of an electric guitar the upper connector 7 can be constituted by the jack plug (not shown). The strap buttom may also serve as connector.

The guitar 1 and the foot member 6 can easily be interconnected by simply pushing the male lower connector 9 into the female upper connector 7, e.g. a bore of a jack plug, after which the guitar 1 is ready for being placed in either a playing position, in which the guitar 1 can be used for playing music, or a parking position, in which the guitar 1 safely can be placed on the ground or other surface S, in an upright position in which the head 3 is uppermost and the instrument body 5 lowermost.

A desired nice baseless appearance of the interconnected guitar 1 and foot member 6 is achieved by forming the foot member 6 so that it's area in substantially horizontal directions are small enough to fit within the border of the lower end face 8 of the instrument body 6 of the guitar 1, thus so that no part of the foot member 6 extends beyond said border when the foot member 6 is placed and mounted underneath the guitar 1.

That construction provides the advantage that the foot member 6 on the guitar 1 cannot be seen in the parking position of the guitar 1 from the normal eye level of a standing or sitting person (not seen), which person gets the impression that the guitar floats in the air without suspension means.

Said construction is according to the invention improved by designing the length of the foot member 6 similar to or smaller than the length of the lower end face 8 of the instrument body 5 of the guitar in a first direction along said length, and similar to or shorter than the width or thickness of said end face 8 in a second direction perpendicular to the first direction.

Besides the same nice appearance is furthermore obtained that the interconnection of the guitar 1 and foot member 6 is very stable despite taking up only limited space on the ground S and in the room. E.g. the stand 2 allows the guitar 1 to be placed stable close to a wall or a piece of furniture without protruding and taking up more space than a perpendicularly erected guitar 1 without a stand 2 would normally do. There are no protruding legs, nor any backrest that needs accommodation space at the floor S and inside the relevant room.

The first axis 10 of the upper connector 7 is coincident with the second axis 11 of the instrument body 5, while the third axis 12 of the lower connector 9 is coincident with the fourth axis 13 of the foot member 6 to serve as a firm socket for the parked guitar 1.

All of the first, second, third and fourth axes 10, 11, 12, 13, respectively, are in the present example moreover coincident with each other so that the foot member 6 advantageously can be kept in balance when the guitar 1 has been placed in the parking position.

In order to avoid that the assembled guitar 1 and foot member 6 turns over in the parking position the fourth axis 13 of the foot member 6 passes through the centre of gravity of the guitar 1.

The topside of the foot member 6 is formed as a curve with curvature having a first radius 14 similar to or smaller than the second radius 15 of the curved end face 8 of the body 5. The centre of the curve is moreover situated on the second axis 11 of the instrument body 5 in the interconnected state of the upper connector 7 and the lower connector 9, whereby advantageously is obtained that the foot member 6 reliable bears against the guitar 1.

In a simple and inexpensive embodiment of the upper connector 7 and the lower connector 9, as best seen in FIG. 2, the upper connector is a bush 7′ with a hole 16 while the lower connector is a tap 9 fitting into said hole 16.

To be entirely sure that the foot member 6 remains assembled to the guitar 1 in the parking position, optionally in the playing position, at least the free end of the tap 9 is covered with an elastic friction lining formed, in this exemplary case, as at least one rubber ring 17 with an outer diameter somewhat larger than the inner diameter of the hole 16 in the bush 7 and an axis coincident with the third axis of the tap.

FIGS. 3, 4 and 5 show a second embodiment of a stand 18 according to the invention in which the upper connector on the contrary is used as a tap 7″ (see FIG. 2) while the lower connector is a bush in form of a clamping means 19, 20, which fits together with and clamps around the tap 7″. The clamping means 19, 20 consists of a stationary jaw 19 and a movable jaw 20. In this second embodiment 18 the upper connector 7″ is e.g. the exterior of the jack plug of the guitar 1 which exterior serves as a tap 7″. So the jack plug is utilized as an upper male connector. In contrast, for the first embodiment the bore of the tap or of the jack plug was used as a female upper connector.

The foot member 6′ is assembled of an upper foot member housing part 6a and a lower foot member housing part 6b.

The movable jaw 20 is part of a slide 23 introduced in an adapter 24 placed in a transverse recess 25 in the lower foot member part 6b in mounted position.

The clamping means 19, 20, the adapter 25 and the slide 23 are accommodated between the upper and lower foot member parts 6a, 6b. Any additional operative components for the clamping means to be operative may also be confined between the upper and lower foot member parts 6a, 6b, which upper and lower foot member parts 6a, 6b may be configured with sub-compartments, recesses and similar structural features to properly mount and position the clamping means to be operative. The upper and lower foot member parts 6a, 6b thus define and delimit a clamp compartment 29 with an opening 30 for entry of the upper connector, thus the tap 7″.

The stand 18 is in FIG. 3 shown in a starting position, in which the clamping means 19, 20 has been opened so much that the clamping means 19, 20 can be set on the tap 7″.

In FIG. 4 the stand 18 is shown in a closed position in which the clamping means 19, 20 has been attached (not shown) to the tap 7″ by means of a spring 21 arranged for closing the clamping means 19, 20 by driving the movable jaw 20 against the stationary jaw 19.

The spring 21 is however not acting directly on the slide 23 with the movable jaw 20 but via a lever 26 pivotally placed on a pivot tap in the transverse recess 25 in the foot member 6′ whereby the spring 21 is pulling at a first pivot tap 27 on the lever 26 so that the lever 26 clockwise is turned from an open to a closed position of the movable jaw 20 because a second pivot tap 28 on the lever 26 at the same time is pushing at the slide 23.

The tap 7″ is in this case formed with a conical groove 22 (see FIG. 2) while the clamping means 19, 20 is formed with an opposite rib whereby the foot member 6′ and the guitar 1 achieve a very high security against being unintentionally separated from each other.

The spring of the adapter 23 can be operated by the fingers on just one hand without particular force.

FIG. 6 is a side view of the stands 2; 18 when assembled. The lower end face 8 of the instrument body 5 of the guitar 1 is raised a distance corresponding to the height of the foot member 6; 6′ above the surface S on which the guitar 1 is parked by means of the stand 2; 18 of the present invention. The outline of the foot member 6; 6′ does not go beyond the physical border of this lower end face 8, so that it when seen from a distance or above it will look like the guitar 1 is hanging in the air without strings or base support, although such base support in fact are provided by means of the foot member 6; 6′.

FIGS. 7 and 8 are exploded perspective views of the main components of a third embodiment of a stand 31, and FIG. 9 shows the same in assembled state ready for being mounted to a stringed instrument 1.

The third embodiment of a stand 31 comprises a third embodiment of a foot member 32 accommodating a second embodiment of a clamping means. The second embodiment of a clamping means 38 comprises a second spring mechanism 36 arranged resiliently in a spring compartment 35 of a lower foot member part 32b, which second spring mechanism 36 constitutes or is part of a lower female connector (not shown). The lower foot member part 32b of the foot member 32 is substantially cross-shaped with a centre body 33 wherefrom four support legs 34 radiate. The second spring mechanism 36 is situated in operative manner in the spring compartment 35 of the centre body 33. An upper foot member part 32a defines a cover 32a for the spring compartment 35, which cover 32a has an access port 37 for guiding and receiving an upper male connector, e.g. the male upper connector seen in FIG. 2, into engagement with the second spring mechanism 36.

The second spring mechanism 36 has a first spring leg 38 opposite and spaced apart from a second spring leg 38, which opposite spring legs 38, 39 are arranged substantially parallel to a main plane of the lower foot member part 32b for interconnection of the upper male connector by sideways displacement of said upper connector between said spring legs 38, 39.

The centre body 33 may have a through-hole 40 through the spring compartment 35 for allowing one and the same stand 31 to be used for various lengths of upper connectors. Alternatively the bottom face 41 of the lower foot member part 32b may be closed at the bottom of the spring compartment 35 and the depth of the spring compartment 35 be adapted to receive various lengths of upper connectors (not shown).

The spring compartment 35 and the second spring mechanism 36 are designed to retain the second spring mechanism 36 in sideways operative flexible condition, so as to resiliently allow an upper connector to firmly engage between the spring legs 38, 39 and be detached from said spring legs 38, 39 in a easy and fast operation.

To that aspect the exemplary second spring mechanism 36 is formed substantially as a hairpin, where the first spring leg 38 is substantially straight and the opposite second spring leg is e.g. wavy or zig-zagged, so as to obtain at least one section 42 that has an increased distance to the first spring leg 38 compared to the distance between said spring legs 38, 39 just below a bend 46 and the distance below the at least one section 42, thereby, inbetween said spring legs 38, 39 at this wider section 42 of the second spring mechanism 35, defining a spring clamp for ensuring the same engagement position and same firm engagement to the upper connector each time interconnection takes place.

The first spring leg 38, which is straight, has a free first end 43 secured to a first side wall 44 of the spring compartment 35, and extends from said free first end 43 via the bend 46 into the second spring leg 39, which second spring leg 39 has a section 42 in form of at least one sideways bulge 47 or convex curvature away from the first spring leg 38. The second spring leg 39 ends in a second free end 48, that in the third embodiment of a stand 31 shown in FIGS. 7, 8 and 9, is bend away from the first free end 43 of the first spring leg 38 to provide a comfortable easy accessible gap opening 49 for the sideways displacement and inserting of an upper male connector (not shown).

The spring compartment 35 features an upright protrusion 52 for securing of the bend 46 so that the second spring leg 39 can flex to the side freely upon receiving and engaging an upper male connector. The spring compartment 35 has a second side wall 50 opposite the first side wall 44, which second side wall 50 has a first recess 60 adapted to provide a temporary space for the sideways flexing of the second spring leg 39 when the upper male connector spreads the first spring leg 38 and the second spring leg 39 apart when said upper connector is inserted in the gap opening 49 between the first free end 43 of the first spring leg 38 and the second free end 48 of the second spring leg 39.

The spring compartment 35 may be provided with an annular recess 51 to place the cover 32a in the plane of the topface of lower foot part 32b, e.g. by means of screws (not shown) in respective screw holes 53a, 53b. The access port 37 is sized and aligned with the second spring mechanism 36 so that at least the gap opening 49 and the bulge section 42 of the second spring mechanism is operatively accessible to an upper male connector.

The radiating free ends 34a of the support legs 34 each has a threaded leg hole 55 for screwing in a respective adjusting screw 56. Only one adjusting screw is seen FIG. 9. An adjusting screw 56 has an upper screw end 57 provided with a protective member 58, and an opposite lower screw end 59. The upper screw end 57 is thus above the top face 53 of the foot member 32 and can be screwed into abutment with the lower end face 8 of the instrument body 5. The lower screw end 59 rests on the surface S on which the stringed instrument 1 is parked.

As seen best in FIG. 8 the cover 32a is adapted to retain the second spring mechanism 36 to protrude sideways in the spring compartment 35 once said cover 32a has been secured to the top face of the foot member 32b. To that aspect the cover 32a has a foot member facing side 61 provided with a retainer recess 61a defining opposite first spring retainer side wall 62 and second spring retainer side wall 63 for arranging matingly above respective first side wall 44 and second side wall 50 of the spring compartment 35 to firmly confine the spring mechanism 36. The second spring retainer sidewall 63 has a second recess 64 that mates above the first recess 60 of the second sidewall 50 of the spring compartment 35.

Although the third embodiment of the present invention is shown to be substantially cross-shaped, polygonal or solid foot members are also possible for the third embodiment of a stand 31. More or less support legs may be provided and one or more of the support legs may have any of adjusting screws and protective members.

Features of one of the various embodiments described above and shown in the figures may be implemented in another of the embodiments to the extent possible. For example can the foot member of the second embodiment of a stand incorporate a centre body with a spring compartment as in the third embodiment of a stand. Support legs need not have adjusting screws nor protective members, however adjusting screws can quite as well be provided to any of the first and second embodiments of a stand according to the present invention. Emphasis is made that the adjusting screws also may serve as tightening screws to ensure the correct “base-less” and “floating” appearance when the stand is secured to the stringed instrument.

The stands of the present invention can be used by everybody. It is easy to bring along and the stands can be stored in the portable instrument casing together with the musical instrument. Alternatively the stand can be transported snapped to the strap, which the musician uses to hang the instrument on to his/her body when playing.

The jack plug is expediently utilized in most embodiments, but for musical instruments without a jack plug, separate upper connectors may be available for being mounted to the musical instrument to fit firmly together with the lower connector of the foot member. The starp button is another option for use as connector.

The size of the foot member can be adapted to the size of the instrument,d to the dimensions of the jack plug, the strap button or any other upper connector, so that irrespective of the musical instrument, a suitable stand exists that offers a reliable and instant connection and disconnection.

The stand according to the present invention can keep the stringed instrument perpendicular to the surface where the stringed instrument is parked.

1. A stand (2; 18; 31) configured to arrange a stringed instrument (1) in an erected parking position, characterized in that
the stand (2; 18; 31) comprises a foot member (6; 6′; 32) with a lower connector (9; 19, 20; 36) configured to interconnect with an upper connector (7; 7″) located at the lower end face (8) of the instrument body (5) in the erected parking position, and
the stand (2; 18; 31) has no backrest for the stringed instrument (1) when said stringed instrument (1) is in the parking position.

2. A stand (2; 18; 31) according to claim 1, characterized in that the foot member (6; 6′; 32) has a size and shape that does not extend a geometrical border of the area of the mounting location of the lower end face (8) of the instrument body (5) when the stringed instrument (1) is in it's parking position.

3. A stand (2; 18; 31) according to any of claim 1 or 2, characterized in that in the parking position of the stringed instrument a first axis (10) of the upper connector (7; 7″) is coincident with a second axis (11) of the instrument body (2).

4. A stand (2; 18; 31) according to any of claim 1, 2 or 3, characterized in that a third axis (12) of the lower connector (9; 19, 20; 36) is coincident with the fourth axis (13) of the foot member (6; 6′; 32).

5. A stand (2; 18; 31) according to claim 3 or 4, characterized in that the first, second, third and fourth axis (10, 11, 12, 13) are coincident.

6. A stand (2; 18; 31) according to claim 4 or 5, characterized in that the fourth axis (13) of the foot member (6; 6′; 32) is passing through the centre of gravity of the instrument (1).

7. A stand (2; 18; 31) according to any of the preceding claims 1-6 characterized in that a top side of the foot member (6; 6′; 32) has a concave curvature so that a first radius (14) of said curvature corresponds to or is shorter than the second radius (15) of the lower end face (8) of the instrument body (5), and that the centre of the curvature is situated on the second axis (11) of the instrument body (5) in the interconnected state of the lower connector (9) and the upper connector (7; 7″).

8. A stand (2) according to any of the preceding claims 1-7, characterized in that the upper connector (7) is a female connector and the lower connector (9) is a male connector.

9. A stand (18; 31) according to any of the preceding claims 1-7, characterized in that the upper connector (7″) is a male connector and the lower connector (19, 20; 36) is a female connector.

10. A stand (2; 18; 31) according to any of the preceding claims 1-9, characterized in that the upper connector (7; 7″) has both male and female properties.

11. A stand (2; 18; 31) according to any of the preceding claims 1-10, characterized in that one of the connectors (7) is a bush (7′) with a hole (16) for engaging a tap (9) of the other connector (9, 7).

12. A stand (2; 18; 31) according to any of the preceding claims 1-11, characterized in that the upper connector (7; 7″) is a jack plug or a strap button of the stringed instrument (1).

13. A stand (2; 18; 31) according to any of the preceding claims 1-12, characterized in that at least one of the upper connector (7; 7″) or the lower connector (9; 19, 20; 36) has means for providing friction against the respective other of said connector (7; 7″) when interconnecting.

14. A stand (2; 18; 31) according to claim 13, characterized in that the means for providing friction is an elastic lining (17).

15. A stand (2; 18; 31) according to claim 14, characterized in that the elastic lining is at least one elastomeric ring (17).

16. A stand (2; 18; 31) according to any of the preceding claims 1-15, characterized in that the lower connector (9) is a clamping means (19, 20) for clamping around a male upper connector (7″) protruding from the instrument body (5).

17. A stand (2; 18) according to claim 16, characterized in that the clamping means (19, 20) comprises a stationary jaw (19) and a movable jaw (20), which movable jaw (20) is forcible against the stationary jaw (19) by means of a first spring mechanism (21).

18. A stand (18) according to claim 16 or 17, characterized in, that the upper connector (7; 7″) is formed with at least one groove (22) and the clamping means (19, 20) is formed with a rib fitting into said groove (22).

19. A stand (18) according to any of the claim 17 or 18, characterized in that the stationary jaw (19) is part of an adaptor (24) in the foot member (6).

20. A stand (18) according to any of claims 16, characterized in that the clamping means (19, 20) comprises a second spring mechanism (36) accommodated in a spring compartment (35) in the foot member (32), via which spring compartment (35) the second spring mechanism (36) is accessible to interconnect with the upper connector (7; 7″).

21. A stand (31) according to claim 20, characterized in that a second spring mechanism (36) of the lower connector (31) comprises a first spring leg (38) opposite and spaced apart from a second spring leg (39), which opposite spring legs (38, 39) are arranged substantially parallel to a main plane of the foot member (32) for interconnection of the upper connector (7; 7″) by sideways displacement of the upper connector (7; 7″) between said spring legs (38, 39).

22. A stand (2; 18; 31) according to any of the preceding claims 1-21, characterized in that the foot member (6; 6′, 32) has an adjusting screw (56).

23. A stand (2; 18; 31) according to any of the preceding claims 16-22, characterized in that the foot member (32) has a centre body (33) comprising the spring compartment (35) and/or the clamping means (19, 20) and at least two support legs (34) radiating from the centre body (33).

24. A stand (2; 18; 31) according to claim 23, characterized in that at least one or more of the support legs (34) of the foot member has at least one adjusting screw (56).

25. A stand (2; 18; 31) according to any of the claim 22, 23 or 24, characterized in that an end (57) of an adjusting screw (56) that faces towards the end face (8) of the instrument body (5) in the parking position has a protective termination (58).

26. A stand (2; 18; 31) according to any of the preceding claims 1-25, characterized in that the stand is detachable.

27. A stand (2; 18; 31) according to any of the preceding claims 1-26, characterized in that the erected parking position is substantially vertical.

28. A stand (31) according to any of the preceding claims 16-27, characterized in that the foot member (32) is formed as a cross body (32) where the lower connector (36) are situated at a centre part (33) or at an intersecting part of the legs (34) of the cross, and the legs (34) of the cross body radiate, preferably in the plane of the foot member (32), from the centre part (33) or the intersection part.

29. A stand (31) according to claim 28, characterized in that the centre part (33) or the intersecting part of the cross body (32) includes the spring compartment (35) and/or the adapter (24), and the support legs (34) radiate from said respective spring compartment (35) or the adapter (24).

30. A stand (2; 18; 31) according to claim 29, characterized in that the legs (34) of the cross body (32) are the support legs 34).
